(19) United States
(12) Patent Application Publication
(10) Pub. No.: US 2011/0104321 A1
(43) Pub. Date: May 5, 2011

(54) METHOD FOR REPLICATING MASTER MOLDS

(76) Inventors: Jun-Ying Zhang, Woodbury, MN (US); Terry L. Smith, Roseville, MN (US); Haiyan Zhang, Woodbury, MN (US)

(21) Appl. No.: 12/673,549

(22) PCT Filed: Oct. 31, 2008
(86) PCT No.: PCT/US08/81928

§ 371 Date: Feb. 15, 2010

Related U.S. Application Data
(60) Provisional application No. 60/984,616, filed on Nov. 1, 2007.

(51) Int. Cl. B29C 59/02; B22C 3/00

(52) U.S. Cl. 425/385; 427/135

(57) ABSTRACT

The disclosure provides a method of replicating a master using a patterned silicone daughter mold, from a master mold, the daughter mold having a layer of a ductile metal on the patterned surface thereof.

### FIELD OF THE INVENTION

This invention relates to molds and the replication of surfaces bearing microstructures and/or nanostructures, in the production of shaped articles such as retroreflecting cube-corner sheeting, Fresnel lens elements, diffraction gratings, video discs, photonic crystal structures, microfluidic channels, and ophthalmic lenses, and to a process for the preparation of the mold.

### BACKGROUND

There is an interest in commercial and industrial applications to reduce the size of articles and devices, such as in electronics where devices have been made smaller and smaller. Micro- and nanostructured devices, for example, can be used in articles such as flat panel displays, chemical sensors, and bioabsorption substrates. Microstructured articles have found commercial utility in, for example, electroluminescent devices, field emission cathodes for display devices, microfluidic films, and patterned electronic components and circuits.

Various mold-based micro and nano-replication technologies have been reported, such as nano-embossing lithography, nano-imprint lithography, ultraviolet-nano-imprint lithography, and step-and-flash imprint lithography. In the nanoreplication process, replica quality can be negatively affected by interfacial phenomena such as wettability and adhesion between the mold and the replicated polymeric patterns. Such effects are particularly important for nanoscale features, due to the high surface to volume ratio of those features. In nanoreplication applications, where the pattern sizes of the mold are very small—on the order of micrometers to nanometers—conventional molding technology cannot be applied because a thick release layer on the mold can change the feature dimensions of the pattern.

### SUMMARY

Although various lithographic techniques have been developed to produce nano-sized features, such techniques are not suitable for large-scale production due the high cost and low throughput. Several improvements are required before “soft” lithographic techniques can be viable in commercial production including improvement in registration with elastomeric materials (such as PDMS), better control of the distortion and deformation associated with elastomeric materials, better reproducibility of pattern transfer from a master mold, and improved quality of the transferred pattern elements.

The present disclosure provides a process to transfer the pattern from a silicone daughter mold (made from a master mold) to a more rigid and durable material, which then serves as a submaster for production. The method comprises: providing a patterned silicone daughter mold; depositing a layer of a ductile metal on the patterned surface of said daughter mold; next depositing a layer of nickel metal on the patterned surface of said daughter mold; optionally securing the article of the previous step to a substrate; and separating the deposited nickel layer having a patterned surface to produce a submaster mold, said patterned surface having a layer of a ductile metal thereon.

The present invention provides method for producing a negative or a positive submaster mold from a master. It is desirable to make submaster molds from a master mold because it enables the preparation of multiple copies of the master mold that may be used in production of shaped articles without relying on the master, and may be tiled to more efficiently produce such shaped articles.

The present invention overcomes problems in the art by providing a method that may be used repeatedly in preparing replica molds (submaster molds) from a master mold with little or no degradation in fidelity to the master. The submaster may have the same pattern of the master or the negative thereof, as desired. It has been found that the deposited layer of ductile material preferentially adheres to the nickel deposited layer upon separation from the daughter mold, improving the fidelity in subsequent casting processes, and it is deleterious to remove the ductile metal layer by, for example, etching.

In one embodiment, the silicone daughter mold is a first generation daughter mold prepared directly from the master mold, the method comprising:

a) providing a master mold have a positive pattern on the surface thereof;

b) contacting the master mold having a positive pattern with a curable silicone and curing,

c) removing the cured silicone mold having a negative pattern on the surface thereof (the first generation daughter mold),

d) first depositing a layer of a ductile metal on the negative patterned surface;

e) next depositing a layer of nickel metal on the negative patterned surface;

f) optionally securing the article of step e to a substrate; and

g) separating the electroplated nickel layer having a negative patterned surface to produce a submaster mold, said patterned surface having a layer of a ductile metal thereon.

In another embodiment, the silicone daughter mold is a second generation daughter mold prepared through an intermediate step of casting and curing on a first generation daughter mold, the method comprising the steps of:

a) providing a master mold have a positive pattern on the surface thereof;

b) contacting the master mold with a curable silicone and curing,

c) removing the cured silicone mold having a negative pattern on the surface thereof (the first generation daughter mold),

d) contacting the cured silicone mold having a negative pattern on the surface thereof with a curable silicone and a release agent;

e) removing the cured secondary silicone mold having a positive pattern on the surface thereof (the second generation daughter mold);

f) first depositing a layer of a ductile metal on the positive patterned surface;

g) next depositing a layer of nickel metal on the positive patterned surface;

h) optionally securing the article of step g to a support;

i) separating the electroplated nickel layer having a positive patterned surface to produce a submaster mold, said patterned surface having a layer of a ductile metal thereon.

It will be understood that the terms “positive patterned surface” and “negative patterned surface” merely indicate that the patterns are the inverse of one another, and do not indicate the spatial relationship of the mold or pattern elements thereof.

As used herein, the articles “a”, “an”, and “the” are used interchangeably with “at least one” to mean one or more of the elements being described.

“etch mask” refers to a structure that is held in proximity to or in contact with the substrate so as to allow or to prevent exposure of regions of the substrate to optical or etchant beams.

“etch resist” refers to a layer or layers of material that is placed on the substrate and can be patterned to form a resist pattern, which, under the etching conditions used, etches more slowly than the substrate.

“resist” refers to a layer or layers of material that is placed on the substrate to selectively allow an etching agent to pass through in a patterned manner, as in photolithographic processes.

“microstructure” or “microstructures” refer to structures that range from about 0.1 microns to about 1000 microns in their longest dimension. In this application, the ranges of nanostructures and microstructures may overlap.

“nano”, as in “nanofeature” or “nanostructure” refer to pattern features or elements that range from about 1 nm to about 1000 nm in their longest dimension;

“pattern” or “patterns” refer to a configuration or configurations that can include regular arrays or random arrays of features or structures or a combination of both; and

### BRIEF DESCRIPTION OF THE DRAWINGS

FIGS. 1 and 2 illustrate the methods of replicating a master mold.

FIGS. 3 and 4 are digital images a mold of Comparative Example 2.

FIG. 5 is a digital image of the mold of Example 3.

FIG. 6 is a digital image of the replicated mold of Example 3.

### DETAILED DESCRIPTION

The present disclosure provides methods of replicating master molds, allowing the efficient production of shaped articles, including optical articles from the “submasters”. A submaster is a replica of the master mold that may be efficiently replicated from the master and allows subsequent production of shaped articles such as retroreflecting cube-corner sheeting, Fresnel lens elements, diffraction gratings, video discs, photonic crystal structures, microfluidic channels, and ophthalmic lenses.

In the methods of this disclosure a patterned master mold is provided bearing the desired pattern on the surface thereof, which is desirably replicated to produce submasters, which in turn are used in the production of shaped articles, such as optical articles. The master for use with the above described method may be a metallic master, such as nickel, nickel-plated copper or brass, although the master can also be constructed from thermoplastic materials, such as a laminate of polyethylene and polypropylene. One useful master mold is a sheet of thermoplastic resin that is stable to the curing conditions and has been embossed by a metallic master tool such as nickel-plated copper or brass. Such a thermoplastic master is relatively inexpensive and yet can be used to form many patterned absorbent layers before becoming unduly worn.

A partial listing of illustrative methods for generating a master mold with patterned surfaces includes diamond machining (M. A. Davies, C. J. Evans, S. R. Patterson, R. Vohra, and B. C. Bergner, “Application of Precision Diamond Machining to the Manufacture of Micro-photonics Components,” Proc. of SPIE 5183 94-108 (2003)), optical lithography, interference lithography, e-beam lithography, x-ray lithography, gray-scale lithography, laser beam writing, electron beam writing, two photon processes, and laser ablation (E. B. Kley, “Continuous Profile Writing by Electron and Optical Lithograph,” Microelectronic Engineering 34 261-298 (1997)). Methods for generating a structured surface may include a step where material is exposed to light, X-rays, or electrons and then developed and selectively removed, or a step where a material is etched (Y. Hagiwara, N. Kimura, and K. Emori, U.S. Pat. No. 4,865,954 “Process for Formation of Metallic Relief” (1989)). Material (e.g., metal) can be selectively added onto the substrate surface, to form a structured surface, by convention methods including, for example, sputtering, vapor deposition, and the like. Material (e.g. metal) can be removed from the substrate to form a patterned surface, by convention methods including, for example, etching and the like. These addition and removal methods can be combined with other methods such as, for example, photolithography methods and lift-off methods.

Particularly advantageous approaches for the preparation of a master mold with patterned surfaces include replication offorming a microstructure with a mechanical tool. Mechanical tools form a microstructured surface by embossing, scribing, or molding the microstructure onto the substrate surface. Replication includes the transfer of surface structural feature from a master tool to another material and includes embossing or molding. Methods involving replication are noteworthy for the ease and speed with which materials with structured surfaces can be generated. Also noteworthy is the small size that can be achieved for surface structure features that are generated through replication. Nanoscale features with size less than 10 nanometers, can be replicated (S. R. Quake and A. Scherer, “From Micro- to Nanofabrication with Soft Materials,” Science 290 1536-1540 (2000); V. J. Schaeffer and D. Harker, “Surface Replicas for Use in the Electron Microscope,” Journal of Applied Physics 13, 427-433 (1942); and H. Zhang and G. M. Bensen, WO 0168940 A1, “Methods for replication, replicated articles, and replication tools” (2001)).

A master mold with patterned surfaces can be prepared through thermal embossing (M. J. Ulsh, M. A. Strobel, D. F. Serino, and J. T. Keller, U.S. Pat. No. 6,0986,247 “Embossed Optical Polymeric Films” (2000); and D. C. Lacey, U.S. Pat. No. 5,932,150 “Replication of Diffraction Images in Oriented Films” (1999)). Thermal embossing involves the pressing of a master mechanical tool against a deformable material, causing the surface structure of the master tool to deform the surface of the deformable material, thereby generating a negative replica of that master tool surface.

Materials that can be embossed with surface structure include, for example, soft metals and organic materials such as polymers. Polymers suitable for thermal embossing include thermoplastics. Examples of thermoplastics include polyolefins, polyacrylates, polyamides, polyimides, polycarbonates, and polyesters. Further examples of thermoplastics include polyethylene, polypropylene, polystyrene poly(methylmethacrylate), polycarbonate of bisphenol A, poly(vinyl chloride), poly(ethylene terephthalate), and poly(vinylidene fluoride). For the preparation of thermally embossed materials, it is often convenient and useful to start with material in film form. Optionally, a film for embossing can include multiple layers (J. Fitch, J. Moritz, S. J. Sargeant, Y. Shimizu, and Y. Nishigaki, U.S. Pat. No. 6,737,170 “Coated Film with Exceptional Embossing Characteristics and Methods for Producing It” (2004); and W. W. Merrill, J. M. Jonza, O. Benson, A. J. Ouderkirk, and M. F. Weber, U.S. Pat. No. 6,788,463, “Post-Formable Multilayer Optical Films and Methods of Forming” (2004)).

Another illustrative method for generating a master mold with patterned surfaces is by scribing. “Scribing” refers to the application of a stylus to an otherwise unstructured surface and pressing or translating the stylus on the surface, generating surface microstructure. A stylus tip may be made of any material such as, for example, a metal, ceramic, or polymer. A stylus tip may include diamond, aluminum oxide, or tungsten carbide. A stylus tip may also include a coating, for example a wear-resistant coating such as titanium nitride.

When preparing a mold of the invention, having nano- and/or micro- size pattern elements, it is desirably prepared from a master mold using techniques including laser ablation mastering, electron beam milling, photolithography, x-ray lithography, machine milling, and scribing.

The pattern of the master mold, and subsequently imparted to the 1st generation negative mold of the invention, and subsequent shaped articles prepared from the 1st generation negative mold, such as 2^{nd} generation daughter molds, may be any suitable preselected three-dimensional pattern. The pattern may comprise an array of pattern elements that include, but are not limited to, ridges, channels, mounds, peaks, hemispheres, pyramids, cylinders, cones, blocks, and truncated variations and combinations thereof. The pattern elements may be random or non-random in the x direction, the y direction, or both, with x and y defining the major planar dimensions of the mold. The size of the individual pattern elements may be any suitable size. Generally the individual pattern elements are from about 100 nanometers'to 15,000 micrometers, preferably about 100 nanometers to 5000 micrometers in cross section (independently height and width dimensions) and have a repeat distance (i.e. that distance from one element to the next, peak to peak) of 10 nanometers to 15,000 micrometers. The minimal distance between adjacent elements may vary from 0 to 10,000 micrometers. Thus, there may be a flat, unpatterned surface area between adjacent elements, or the elements may be continuous.

When the thermoplastic master mold is made from a radiation-transparent thermoplastic material, a radiation-curable silicone resin can be cured by being irradiated through the master. By using a radiation-transparent master, integral backing layers for the cured sub-master can be opaque. When the master is made from a radiation-transparent thermoplastic resin such as a polyolefin, it is possible to prepare the patterned 1^{st} generation silicone mold or other shaped plastic article bearing patterns on both surfaces of the cured silicone layer.

In the methods of replication, the silicone resin is added to the master mold to cover the pattern and to fill the voids therein. If the silicone resin precursor is to be thermally or radiation cured, it is desirable to cover the exposed surface with a radiation transparent film or release liner to exclude atmospheric oxygen from the gel precursor, which would tend to interfere with the curing. The silicone resin is added to the mold in amount sufficient to cover the pattern, and achieve the desired thickness and void volume in the product mold. The silicone resin is then cured, and removed from the master mold to produce a first generation daughter mold having the negative pattern of the master.

As the daughter molds are cured silicones, the flexibility and cohesive strength allows them to be easily separated from the master molds. Further, the flexible daughter molds facilitate bending them into suitable shapes, such as cylinders or hemicylinders, to subsequently produce cylindrical submaster molds, which may be used in the continuous production of shaped articles such as retroreflecting cube-corner sheeting, Fresnel lens elements, diffraction gratings, video discs, photonic crystal structures, microfluidic channels, and ophthalmic lenses. Cylindrical daughter molds may be prepared, for example, by securing them to a cylindrical substrate prior or subsequent to deposition of the ductile metal layer. Further, the flexibility of the daughter molds allows them to be arranged in an array of daughter molds with precise registration for subsequent production of submaster molds having larger areas, or different pattern elements in different areas.

The silicone may be selected from a condensation curable silicone, an addition-curable (or hydrosilylation curable) silicone, a free radical-cure silicone, or a cationic-curable silicone. Curable silicones can provide long-term durability and are useful over a wide range of temperature, humidity and environmental conditions, and can be used effectively to bond the laminated body of the invention. In some embodiments, the curable silicones may be photocurable silicones, including UV and visible light curable silicones. In some embodiments, the curable silicone may further comprise a reinforcing agent such as a silica, quartz, and/or MQ resin, which reinforces the cured silicone. Such a reinforcing agent may be added in amounts up to 75 wt. % of the curable silicone composition.

General references regarding curable silicone polymers include Kirk-Othmer Encyclopedia of Polymer Science and Engineering, 2^{nd} edition, Wiley-Interscience Pub., 1989, volume 15, pp. 235-243; Comprehensive Organometallic Chemistry, Ed. Geoffrey Wilkinson, Vol. 2, Chapter 9.3, F. O. Stark, J. R. Falender, A. P. Wright, pp. 329-330, Pergamon Press: New York, 1982; Silicones and Industry: A Compendium for Practical Use, Instruction, and Reference, A. Tomanek, Carl Hanser: Wacher-Chemie: Munich, 1993; Siloxane Polymers, S. J. Clarson, Prentice Hall: Englewood Cliffs, N.J., 1993; and Chemistry and Technology of Silicones, W. Noll, Verlag Chemie: Weinheim, 1960.

The curable silicone can be an addition-cure or hydrosilylation cure silicone comprising an ethylenically unsaturated (e.g. alkenyl or (meth)acryloyl) functional silicone base polymer, a hydride functional cross-linking or chain extending agent (e.g., SiH), and a hydrosilylation catalyst. The silicone base polymer has ethylenically unsaturated (e.g., vinyl, propenyl, higher alkenyl, (meth)acryloyl, etc.) groups which may be present at the ends of the polymer (terminal) and/or pendent along the polymer chain. Preferably the ethylenically unsaturated groups are vinyl or higher alkenyl groups. It may be desirable for a reinforcing agent to be included such as, for example, a silica, quartz, and/or MQ resin containing alkenyl or SiH functional groups. The hydrosilylation catalyst may be a Group VIII metal or metal complex complex or supported metal catalyst, but is typically a noble metal catalyst containing, for example, Pt or Rh.

Addition-cured silicones (e.g., hydrosilylation cured silicones) are generally considered to be of higher quality and are more dimensionally stable than condensation-cured silicones. Unlike condensation-cured silicones, addition-cured silicones, e.g., hydrosilylation-cured silicones do not produce potentially detrimental byproducts during curing. Such silicones differ from condensation-cured silicones in that the hydrosilylation-cured composition typically contains 1) an ethylenically polyunsaturated silicone polymer or oligomer; 2) a “hydrosilane” component containing two or more silane (Si—H) bonds; and 3) a hydrosilylation catalyst such as a platinum catalyst. By “ethylenically polyunsaturated” it is meant a compound or component having a plurality of ethylenically unsaturated groups, such as a plurality of vinyl groups and (meth)acryloyl groups. The ethylenically unsaturated groups and the Si—H groups may be terminal or pendent. In some embodiments, the silicone may have both Si—H bonds and vinyl groups.

A particularly preferred addition-cured silicone is formed by reacting (1) a multiply- ethylenically unsaturated group-containing organopolysiloxane with (2) an organopolysiloxane containing a multiplicity of SiH bonds per molecule (hereinafter “organohydropolysiloxane”). This reaction is typically facilitated by the presence of (3) a platinum-containing catalyst.

The curable silicone composition can be prepared by combining (e.g., mixing together) the ethylenically polyunsaturated organopolysiloxane, the organohydropolysiloxane, and the hydrosilylation catalyst. In one embodiment, the components are pre-mixed into preferably two parts prior to use. For example, part “A” may contain the vinyl-containing organopolysiloxane, and the catalyst, while part “B” may contain the organohydropolysiloxane and optionally vinyl-containing organopolysiloxane. In another embodiment, the components are provided in one part and further contain an ingredient (e.g., a catalyst inhibitor) that inhibits the cure reaction.

Numerous patents teach the use of various complexes of cobalt, rhodium, nickel, palladium, or platinum as catalysts for accelerating the thermally-activated addition reaction (hydrosilylation) between a compound containing silicon-bonded hydrogen and a compound containing aliphatic unsaturation. For example, U.S. Pat. No. 4,288,345 (Ashby et al) discloses as a catalyst for hydrosilylation reactions a platinum-siloxane complex. Additional platinum-siloxane complexes are disclosed as catalysts for hydrosilylation reactions in U.S. Pat. Nos. 3,715,334, 3,775,452, and 3,814,730 (Karstedt et al). U.S. Pat. No. 3,470,225 (Knorre et al) discloses production of organic silicon compounds by addition of a compound containing silicon- bonded hydrogen to organic compounds containing at least one non-aromatic double or triple carbon-to-carbon bond using a platinum compound of the empirical formula PtX₂(RCOCR′COR″)₂ wherein X is halogen, R is alkyl, R′ is hydrogen or alkyl, and R″ is alkyl or alkoxy. The catalysts disclosed in the foregoing patents are characterized by their high catalytic activity. Other platinum complexes for accelerating the aforementioned thermally-activated addition reaction include: a platinacyclobutane complex having the formula (PtCl₂C₃H₆)₂ (U.S. Pat. No. 3,159,662, Ashby); a complex of a platinous salt and an olefin (U.S. Pat. No. 3,178,464, Pierpoint); a platinum-containing complex prepared by reacting chloroplatinic acid with an alcohol, ether, aldehyde, or mixtures thereof (U.S. Pat. No. 3,220,972, Lamoreaux); a platinum compound selected from trimethylplatinum iodide and hexamethyldiplatinum (U.S. Pat. No. 3,313,773, Lamoreaux); a hydrocarbyl or halohydrocarbyl nitrile-platinum (II) halide complex (U.S. Pat. No. 3,410,886, Joy); a hexamethyl-dipyridine-diplatinum iodide (U.S. Pat. No. 3,567,755, Seyfried et al); a platinum curing catalyst obtained from the reaction of chloroplatinic acid and a ketone having up to 15 carbon atoms (U.S. Pat. No. 3,814,731, Nitzsche et al); a platinum compound having the general formula (R′)PtX₂ where R′ is a cyclic hydrocarbon radical or substituted cyclic hydrocarbon radical having two aliphatic carbon-carbon double bonds, and X is a halogen or alkyl radical (U.S. Pat. No. 4,276,252, Kreis et al); platinum alkyne complexes (U.S. Pat. No. 4,603,215, Chandra et al.); platinum alkenylcyclohexene complexes (U.S. Pat. No. 4,699,813, Cavezzan); and a colloidal hydrosilylation catalyst provided by the reaction between a silicon hydride or a siloxane hydride and a platinum (0) or platinum (II) complex (U.S. Pat. No. 4,705,765, Lewis).

Although these platinum complexes and many others are useful as catalysts in processes for accelerating the thermally-activated addition reaction between the compounds containing silicon-bonded hydrogen and compounds containing aliphatic unsaturation, processes for promoting the ultraviolet or visible radiation-activated addition reaction between these compounds may be preferable in some instances. Platinum complexes that can be used to initiate ultraviolet radiation-activated hydrosilation reactions have been disclosed, e.g., platinum azo complexes (U.S. Pat. No. 4,670,531, Eckberg); (η⁴-cyclooctadiene)diarylplatinum complexes (U.S. Pat. No. 4,530,879, Drahnak); and (η⁵-cyclopentadienyl)trialkylplatinum complexes (U.S. Pat. No. 4,510,094, Drahnak). Other compositions that are curable by ultraviolet radiation include those described in U.S. Pat. No. 4,640,939 and 4,712,092 and in European Patent Application No. 0238033. U.S. Pat. No. 4,916,169 (Boardman et al) describes hydrosilylation reactions activated by visible radiation. U.S. Pat. No. 6,376,569 (Oxman et al.) describes a process for the actinic radiation-activated addition reaction of a compound containing silicon-bonded hydrogen with a compound containing aliphatic unsaturation, said addition being referred to as hydrosilylation, the improvement comprising using, as a platinum hydrosilylation catalyst, an (η⁵-cyclopentadienyl)tri(σ-aliphatic)platinum complex, and, as a reaction accelerator, a free-radical photoinitiator capable of absorbing actinic radiation, i.e., light having a wavelength ranging from about 200 nm to about 800 nm. The process can also employ, as a sensitizer, a compound that absorbs actinic radiation, and that is capable of transferring energy to the aforementioned platinum complex or platinum complex/free-radical photoinitiator combination, such that the hydrosilylation reaction is initiated upon exposure to actinic radiation. The process is applicable both to the synthesis of low molecular weight compounds and to the curing of high molecular weight compounds, i.e., polymers.

It may be useful to include in the composition additives to improve the working time of the hydrosilylation curable composition. Such hydrosilylation inhibitors are well known in the art and include such compounds as acetylenic alcohols, certain polyolefinic siloxanes, pyridine, acrylonitrile, organic phosphines and phosphites, unsaturated amides, and alkyl maleates. For example, an acetylenic alcohol compound can inhibit certain platinum catalysts and prevent curing from occurring at low temperatures. Upon heating, the composition begins to cure. The amount of catalyst inhibitor can vary up to about 10 times or more of the amount of catalyst, depending upon the activity of the catalyst and the shelf life desired for the composition.

The curable silicone can be at least one free radical-cure silicone comprising a polysiloxane polymer or oligomer having free-radically polymerizable, ethylenically unsaturated groups such as vinyl, allyl, (meth)acryloyl, etc. pendent from the polymer chain and/or the terminal ends. It is desirable for a free radical catalyst to be included for initiating free radical polymerization when the silicone is to be thermally or radiation (e.g., UV or photo) cured. Optionally, a small percentage of a free radically polymerizable vinyl monomer can be included. In addition, a free radically polymerizable cross-linking agent may also be included.

Ethylenically unsaturated free radically polymerizable silicones, including especially the acrylated polysiloxane oligomers and polymers containing terminal and/or pendant ethylenically unsaturated groups, such as acrylate or methacrylate groups, can be prepared by a variety of methods, generally through the reaction of chloro-, silanol-, aminoalkyl-, epoxyalkyl-, hydroxyalkyl-, vinyl-, or silicon hydride-functional polysiloxanes with a corresponding (meth)acryloyl-functional capping agent. These preparations are reviewed in a chapter entitled “Photopolymerizable Silicone Monomers, Oligomers, and Resins” by A. F. Jacobine and S. T. Nakos in Radiation Curing Science and Technology (1992), Plenum: New York, pp. 200-214. Preferred acrylated polysiloxane oligomers include those acryl-modified polydimethylsiloxane resins commercially available from Goldschmidt under the TEGO RC designation and those acrylamido-terminated monofunctional and difunctional polysiloxanes described in U.S. Pat. No. 5,091,483 (Mazurek et al.).

The curable silicone can be at least one condensation-cure silicone. Condensation-curable silicones usually comprise pendent or terminal groups such as, for example, hydroxysilane (i.e., silanol), alkoxysilane or acyloxysilane functional groups that react in the presence of moisture to form cured (i.e., crosslinked) materials. Condensation-curable compositions comprising alkoxysilane or acyloxysilane functionality typically cure in two reactions. In the first reaction, the alkoxysilane or acyloxysilane groups hydrolyze in the presence of moisture and a catalyst to form compounds having silanol groups. In the second reaction, the silanol groups condense with other silanol, alkoxysilane, or acyloxysilane groups in the presence of a catalyst to form —Si—O—Si— linkages. The two reactions occur essentially simultaneously upon generation of the silanol-functional compound. Commonly used catalysts for the two reactions include Bronsted and Lewis acids and are described in the Encyclopedia of Polymer Science and Engineering, 2nd Edition, Volume 15, page 252, (1989). A single material may catalyze both reactions.

A variety of approaches have been used for providing condensation-curable compositions that have acceptable cure rates without processing and storage difficulties. For example, U.S. Pat. No. 2,843,555 describes a two-part system, one part comprising a functional polymer and the other part comprising a catalyst with the two parts being mixed just prior before use. U.S. Pat. No. 5,286,815 discloses an ammonium salt catalyst that is inactive until heated sufficiently to liberate an acid compound that initiates the moisture curing reaction. Alternatively, the condensation-curing agent can be a multifunctional cross-linking agent (e.g., an aminosilane) that serves as both catalyst and cross-linker.

U.S. Pat. No. 6,204, 350 (Liu et al.), describes cure-on-demand, moisture-curable compositions of one or more compounds comprising molecules having reactive silane functional groups and an acid generating material are taught therein. The acid generating material releases an acid upon exposure to heat, ultraviolet light, visible light, electron beam irradiation or microwave irradiation to initiate and accelerate the crosslinking reaction.

The curable silicone can be at least one cationic-cure silicone. Cationic-curable silicones usually comprise pendent or terminal groups such as, for example, epoxy, alkenyl ether, oxetane dioxolane, and/or carbonate functional groups that react in the presence of a cationic catalyst to form cured (i.e., crosslinked) materials. If desired, the cationic curable silicone may further comprise a MQ resin to improve the strength of the cured silicone (joining layer).

The epoxysilicones may be prepared by many methods known in the art such as the chloroplatinic acid catalyzed addition reaction of hydride functional silicones with aliphatically unsaturated epoxy compounds, or the epoxidation of vinyl or like unsaturated siloxanes and Grignard type reactions as for example described by E. P. Plueddemann and G. Fanger, J. Am. Chem. Soc. 81, 2632-35 (1959). A convenient method is the hydrosiloxane addition reaction of unsaturated aliphatic epoxy compounds with hydride-functional silicone oligomers. When this method is used, it is preferred that essentially complete reaction of the SiH sites are accomplished although small amounts of hydrogen attached to silicon can be present. It is also preferred for best results that the epoxysilicone is essentially free from low molecular weight components such as cyclic siloxanes, since their presence in the final cured coating could adversely affect the adhesion property of the silicone.

U.S. Pat. No. 5,409,773 (Kessel et al.) describes one or more epoxysilicones having cycloaliphatic and non-cycloaliphatic epoxy groups in a total number which is about 5 to 50% of the total number of siloxane units, the ratio of the total number of cycloaliphatic epoxy groups to the total number of non-cycloaliphatic epoxy groups being from about 1:10 to 2:1, the epoxypolysiloxane(s) being cured in the presence of a catalytically effective amount of a cationic epoxy curing catalyst.

An article entitled “Cationic Photopolymerization of Ambifunctional Monomers” (J. V. Crivello et al., Macromolekular Symposia, 95, 79-89, (1995)) describes the photopolymerization of “ambifunctional” monomers (i.e., monomers bearing two chemically different reactive functional groups within the same molecule) using cationic catalysts. In one example, an ambifunctional monomer having both epoxycyclohexyl and trimethoxysilyl reactive functional groups is prepared and then subsequently UV irradiated in the presence of a cationic triarylsulfonium catalyst.

The cured silicone is conveniently obtained by mixing the cationic curable silicone and catalyst and optionally the epoxy-terminated silane in a solvent, coating the solution on the substrate and heating at a suitable curing temperature depending on the effectiveness of the catalyst and heat sensitivity of the substrate. Alternatively, the cationic curable silicone may be cured by means of a photoacid generator, which generates one or more molecules of a Bronsted or Lewis acid on exposure to UV or visible light, and without the application of heat. Mixtures of the epoxypolysiloxanes or mixtures of the epoxysilanes may be used.

Curing of the cationic curable silicone can be effected by mixing with conventional cationic epoxy curing catalysts activated by actinic radiation and/or heat. Catalysts activated by actinic radiation are preferred. Examples of suitable photoinitiators are onium salts of a complex halogen acid, particularly the polyaromatic iodonium and sulfonium complex salts having SbF₆, SbF₅ OH, PF₆, BF₄, or AsF₆ anions, as are disclosed in U.S. Pat. No. 4,101,513. Preferred photoinitiators are the iodonium and sulfonium salts most preferably having the SbF₆ anion. Also useful photoinitiators are organometallic complex salts that are disclosed in U.S. Pat. No. 5,089,536, and supported photoinitiators for the actinic radiation activated polymerization of cationically-polymerizable compounds described in U.S. Pat. No. 4,677,137. Suitable heat-activated cationic catalysts which may be used include the heat-activated sulfonic and sulfonylic catalysts described in U.S. Pat. No. 4,313,988.

The viscosity of the uncured silicone resin composition should be within the range of about 1,000 to 5,000 cps. Above that range, air bubbles might be entrapped, and the resin might not completely fill the cavities of the master. If an attempt were made to obtain a viscosity below that range, the overall equivalent weight (weight per number of reactive groups) of the uncured silicone resin typically would be so low that the resin would experience shrinkage upon curing to such an extent that the cured silicone resin would not faithfully replicate the master molding surface. Preferably, the viscosity of the resin is from 2,000 to 3,000 cps. Within that preferred range, the silicone resin composition should completely fill the cavities without any need to apply more than hand pressure. However, when the cavities are unusually deep and/or narrow, it may be desirable to reduce the viscosity below about 2,000 cps, because some shrinkage is to be preferred over any failure to fill the cavities completely.

The cured silicone is then removed from the master mold to produce a first generation daughter mold, having the negative pattern of the master mold. In one embodiment, the first generation daughter mold is provided with a ductile metal seed layer. In another embodiment, the first generation daughter mold is again replicated to form a second generation daughter mold, having the inverse pattern of the first generation daughter mold, or the same pattern as the master mold.

In a first embodiment, the first generation daughter mold is provided with a ductile metal seed layer. “Ductile metal,” as used herein, is defined as any metallic material that may be plastically deformed at the temperatures and pressures of the present invention without tearing. Examples of ductile metals useful in the present invention include, but are not limited to, gold, silver, tin and indium. In some embodiments, the ductile metal may be selected from those a % elongation at break of at least 50%. In some embodiments, the ductile metal has a Vickers hardness of 25 or less. The physical properties being measured on the vapor deposited coating. The useful ductile metals provide a defect- or crack-free layer for subsequent deposition of a nickel metal layer.

The thickness of the ductile metal layer is generally between 10 and 150 nanometers in thickness and may be conveniently provided by vapor deposition techniques. In other embodiments of replicating larger pattern features, or in embodiments where precise replication if not necessary, the ductile metal layer may be thicker. Below about 10 nanometers, the ductile metal layer does not provide a continuous coating for subsequent nickel deposition. Above about 150 nanometers, the ductile metal layer may become too rough for subsequent deposition. Preferably, the ductile metal layer is less than about 100 nanometers. Preferably, the deposited ductile metal layer has a surface roughness, (R_{q}, nm, root mean square roughness), of less than 10 nanometers, preferably less than 5 nanometers, more preferably less than 1 nanometer.

The deposition of the ductile metal layer on the patterned surface of the daughter mold may be achieved using one of several physical vapor deposition techniques known to those of ordinary skill in the art. Such processes include vapor deposition, cathode sputtering, pyrolysis, ion plating, e- beam deposition, and the like. Vapor deposition and cathode sputtering are often preferred in view of the uniformity of structure and thickness that can be obtained. Reference is made to Vacuum Deposition of Thin Films, L. Holland, 1970, Chapman and Hall, London, England with regard to the many available means of providing metal vapors and vapor coating techniques.

Physical vapor deposition (PVD) processes involve the deposition of atoms, typically by evaporation or sputtering in a vacuum. PVD processes can be characterized by the steps of (1) generating a metallic vapor by evaporation or sputtering using resistance, induction, electron-beam heating, laser-beam ablation, direct current plasma generation, radio-frequency plasma generation, molecular beam epitaxy, or similar means; (2) transport of the metallic vapor from the source to the substrate by molecular flow, viscous flow, plasma gas transport, or the like; and (3) nanoparticle growth on the thermoplastic polymer film, wherein nucleation and growth of the nanoparticles occurs. With PVD a variety of substrate temperatures can be used to control the crystallization and growth mode of the material deposited, although generally the temperature of the thermoplastic polymer film is below the distortion temperature of the polymer.

To avoid deformation or melting of the daughter mold during deposition, it is generally maintained at a temperature at or below the distortion temperature of the silicone polymer. The integrity is maintained by controlling the deposition rate so that the temperature of the metal vapor, or the heat released upon deposition (heat of condensation) does not lead to thermal deformation of the surface of the daughter mold. Generally, the temperature of the film is maintained at ambient conditions of the deposition chamber, and no special cooling is required.

In a preferred embodiment, the ductile metal layers are applied to the patterned surface of the daughter mold by electron beam evaporation. This technique is based on heat production by high-energy electron beam bombardment on the metal to be deposited. The electron beam is generated by an electron gun, which uses the thermionic emission of electrons produced by an incandescent filament (cathode). Emitted electrons are accelerated towards an anode by a high difference of potential (kilovolts). The crucible (containing the source metal) itself or a near perforated disc can act as the anode. A magnetic field is often applied to bend the electron trajectory, allowing the electron gun to be positioned below the evaporation line. As electrons can be focused, it is possible to obtain localized heating on the metallic material to evaporate, with a high density of evaporation power (several kW). This allows control of the evaporation rate, from low to very high values. Cooling the crucible avoids contamination problems from heating and degasification.

Physical vapor deposition by sputtering is accomplished in a partial vacuum (between 13.3 to 1.33 Pa for a diode system and between 1.3 to 0.13 Pa for a magnetron system) when the target (usually a cathode) is bombarded with gas ions propelled by an electric field. The sputtering gas is typically a noble gas such as argon but the sputtering gas could include reactive elements that can be incorporated into the deposited film such as the deposition of nitrides, oxides and carbides. When the sputtering gas is ionized a glow discharge or plasma is produced. The gas ions are accelerated towards the target by an electric or electric and magnetic fields. Atoms from the target are ejected by momentum transfer and move across the vacuum chamber to be deposited on the patterned surface of the daughter mold.

In another embodiment, the ductile metal layers are applied to the patterned surface of the daughter mold by sputter deposition. The sputtering apparatus generally consists of a three-source magnetron sputtering system arranged around the outer circumference of a cylindrical chamber containing a rotating drum. The substrates are mounted on the drum and rotated sequentially past positions in front of the sputtering sources at rates of between 1 and 8 rpm. The sources are shielded such that the sample is not coated from any two fluxes at the same time. The rate of material deposition and speed of rotation of the substrate in front of the targets determines the individual layer thicknesses comprising the final catalyst particles. Any vacuum pump that can draw a sufficient vacuum may be used. One such vacuum pump is a Varian AV8 cryopump (Varian Associates, Lexington, Mass.), which can be used in conjunction with an Alcatel 2012A rotary vane-roughing pump (Alcatel Vacuum Products, Hingham, Mass.). The cryopump may be partially isolated from the chamber by a butterfly valve. During deposition pressure may be maintained at 0.28 Pa (2.1 millitorr) as the sputtering gas flow rate may be controlled by appropriate flow controllers. Any inert or reactive sputtering gases may be used. Preferably argon is used. Any appropriate targets and power sources may be used. In one embodiment, an Advanced Energy MDX 500 power supply (Advanced Energy Industries, Inc., Fort Collins, Colo.) is used in the constant power mode of the power supply.

Preferably, the ductile metal layer is deposited by a vapor deposition process whereby metal is heated under reduced pressure until vaporization occurs. Optionally, the metal vaporizes in the presence of a gas stream wherein the gas preferably is inert (nonreactive), although any gas that does not react with the metal may be used. The metallic vapor is transported or directed to patterned surface of the daughter mold (optionally by the gas stream) and deposited by impinging the metallic vapor onto the mold, wherein nucleation occurs. Generally in the absence of a gas stream the physical vapor deposition technique produces a metallic vapor that directly nucleates on the surface.

As previously described, the first generation daughter mold may be provided with the ductile metal layer, or that mold may be used as a mold per se to prepare a second generation daughter mold, having an inverted pattern from the first generation daughter, or the same pattern as the master mold. In this latter embodiment, the first generation daughter mold is contacted with a curable silicone, which is cured and separated to provide a second generation daughter mold. This second generation silicone mold may then be provided with the ductile metal layer, as previously described. However, it is difficult to produce a silicone mold from a silicone mold, due to the mutual affinity, so the first generation daughter mold should be provided with a release agent to allow separation of the second generation form the first generation daughter molds. One such method is to provide the first generation daughter mold with a ductile metal layer, as previous described. The second generation daughter mold may then be easily separated and also provided with a ductile metal layer. Alternatively, the first generation daughter mold may be provided with a release agent, such as that described in Assignee's U.S. Ser. No. 11/845465.

The silicone daughter mold having a layer of ductile metal on the patterned surface is then provided with a layer of nickel. The thickness of the nickel layer may be from about 0.5 to 5 millimeters. Relatively thick layers of deposited nickel may be provided, which provided for a more rigid and robust submaster. The thicker nickel layer may also be machined or ground to provide a planar back surface to the submaster.

A preferred process is electroplating or electrodeposition, wherein the daughter silicone mold is submerged in an electroplating solution and is connected to a power source. The electroplating solution contains ions of the metal to be electroplated. For example, when nickel is chosen, the electroplating solution may be a solution of nickel sulphate or nickel sulphamate. The power source is also connected to a rod or block of the metal to be electrodeposited which is at least partially submerged in the electroplating solution. Electroplating of the metal is conducted by applying a potential difference between the cathode and anode. This causes the metal ions present in the electroplating solution to deposit on surface of the ductile metal layer. Preferably, the metal coating is made of nickel and is applied using a nickel sulphamate solution. Optionally, a second nickel coating may be applied over the first metal coating. If desired, the silicone mold may be secured to a support substrate for the electrolytic deposition to aid in handling.

The rate of electrodeposition depends on, among other things, the composition and concentration of the electroplating solution, time, the chemical nature of the substrate being electroplated, and the current density.

Alternatively, the nickel metal layer may be provided by an electroless process of depositing a metal or a metal compound from an aqueous solution of a salt of said metal. Electoless processes are known and widely used to metallize plastics for making the plastics conductive for; electroplating or for EMI shielding applications (see, e.g., “Electroless Plating, Fundamentals & Applications”, eds. G. 0 Mallory and J. B. Hajdu, American Electroplaters and Surface Finishers Soc., 1990). Deposition of a variety of metals ranging from copper and nickel to silver and gold using this process have been demonstrated. As deposited, electroless nickel is known to be a metastable, supersaturated alloy of phosphorus or boron with nickel, which is either microcrystalline or amorphous depending on the compositions. It has a lower melting point, lower density and lower I thermal conductivity than pure nickel.

Electroless nickel plating is widely used due to the unique properties of the nickel deposits. Typically, its reaction involves the reduction of nickel ions with a reducing agent in the same solution. For example, the reduction of nickel ions with hypophosphite yields alloys of phosphorus and nickel:

Ni⁺²+2H₂PO₂⁻+2H₂O—Ni⁰+2H₂PO₃⁻+2H⁺+H₂

H₂PO2⁻+H—OH—+H₂O+P (alloy with Ni)

After deposition of the nickel layer, it is separated from the silicone daughter mold to produce a submaster mold having a patterned surface and the layer of ductile metal on the patterned surface. It has been observed that the ductile metal layer (deposited on the silicone daughter mold) selectively adheres to, and transfers with, the deposited nickel layer. It is preferred that the ductile metal layer not be etched from the nickel surface to maintain the fidelity to the original master mold. It has been observed that such etching deleteriously affects the dimensions and shape of any subsequently replicated pattern elements.

Prior or subsequent to separation from the silicone daughter mold, the submaster mold may be bonded, secured or otherwise affixed to a support substrate, preferably a rigid support substrate. The support is bonded to the surface opposite the patterned surface- the surface opposite that used for subsequent molding operations, and may comprise pattern elements complementary to the patterns or features on this surface for ensuring good contact and support. The rigid support improves the ability to handle the mold, and also maintains the mold's alignment.

The rigid support typically comprises at least one plastic material, at least one metal material, as well as various combinations thereof. Although typically less preferred, the rigid support may comprise a glass or ceramic material as well. The rigid support may also be a composite such as a laminate, fiber-reinforced plastic, as well as fiber-reinforced metal. Suitable plastics include polyethylene terephthalate, polycarbonate, cellulose acetate butyrate, cellulose acetate propionate, polyether sulfone, polymethyl methacrylate, polyurethane, polyester, polyvinyl chloride, polyimide, polyolefins, polypropylene, polyethylene, and polycyclo-olefins. Suitable metals include aluminums, stainless steels, copper, brass, titanium, and alloys of the same.

The rigid support is typically premanufactured as a separate piece that is attached to the mold. Alternatively, a polymeric rigid support may be provided as a molten and/or unreacted curable composition that is applied to the aligned mold and hardened. The design or shape of the rigid support will vary depending on the intended end us. Typically the rigid support will be largely planar, having a thin, flat cross section. Although, the thickness will vary depending on the material(s) from which it was constructed, typically the thickness of a (e.g. frame-shaped) rigid support is at least 10 mils, and no greater than about 0.5 inches (1.25 cm). Further, the rigid support may be of any suitable size and shape to enable subsequent replication or molding operations of the submaster. In one embodiment, the support may be cylindrically shaped, to which a cylindrically shaped submaster may be bonded for continuous replication operations.

The rigid support may be attached by mechanical means, chemical means, thermal means, or a combination thereof. Alternatively, the rigid support may be provided as a molten and/or unreacted polymeric composition that is applied to the aligned mold and hardened. Chemical means include includes the use of various one- and two-part curable adhesive compositions that crosslink upon exposure the heat, moisture, or radiation. Double sided adhesive tapes are also contemplated.

The submaster is then available for subsequent molding operations. Shaped plastic articles, such as optical films, are typically prepared by pouring or filling submaster (having a layer of ductile metal thereon) with curable silicone resin composition, curing the same, and removing from said mold submaster the resulting shaped silicone articles which comprise cured silicone resin and has a surface bearing microstructure replicated from the mold submaster. The silicone resin is selected from the curable silicones previously described, and may be the same or different from that of the silicone daughter mold. Following curing of the cast silicone resin, the cured, shaped plastic article is readily separated or removed from the mold master. Depending on the particular shaped plastic article made and the nature of the mold master, the master mold can be repeatedly used for replication done on a continuous mass production basis.

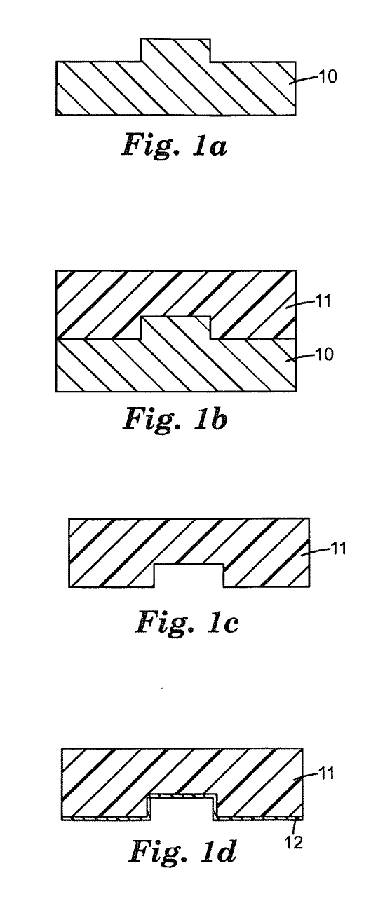

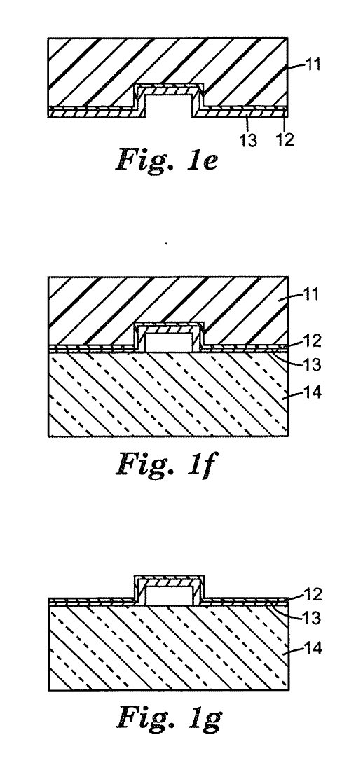

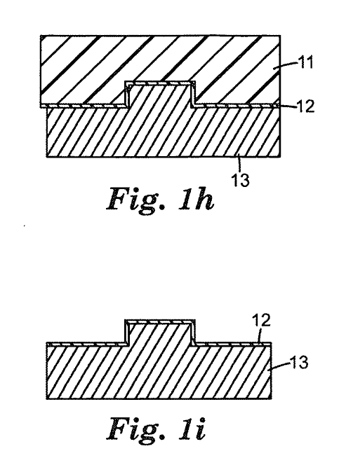

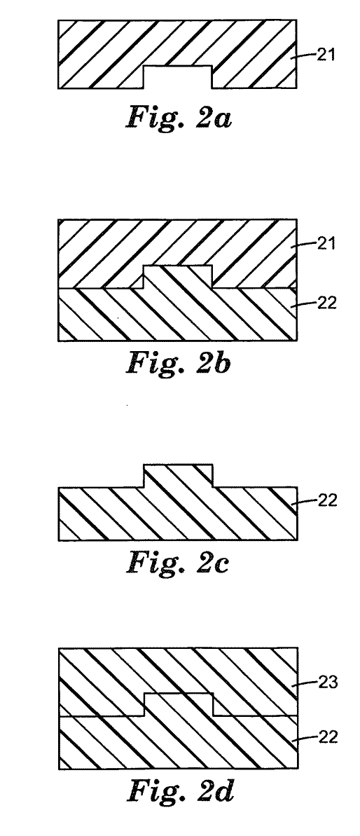

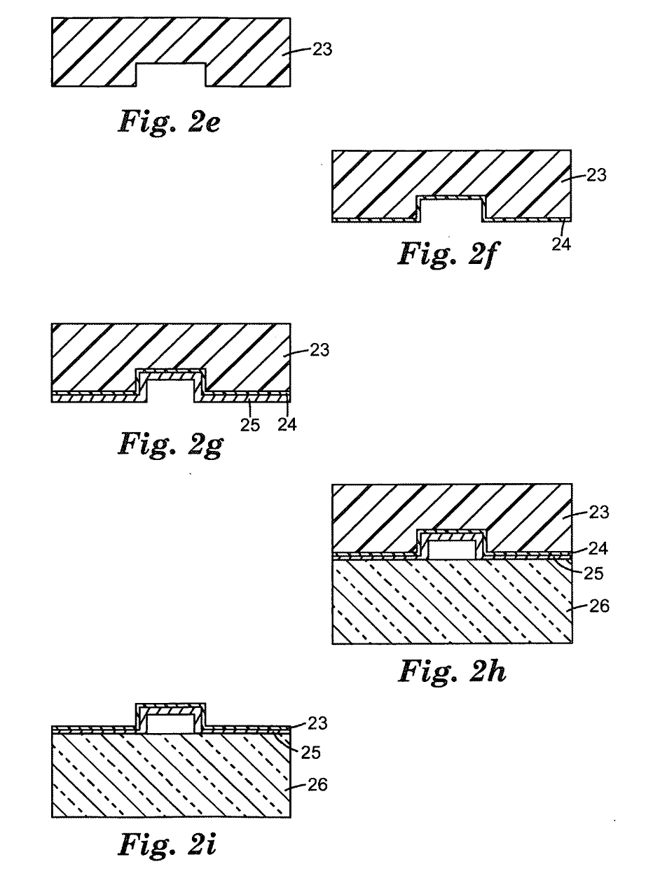

The methods of this invention are illustrated with FIGS. 1 and 2. In FIG. 1 a, a master mold 10 is provided. FIG. 1a shows the master mold with a pattern element protruding above the plane of the mold surface, but other orientations may be used. The master mold 10 is contacted with a silicone resin in FIG. 1b, which is then cured and separated from the master mold in FIG. 1c to provide a silicone first generation daughter mold 11 having pattern elements negative those of the master. The daughter mold 11 is then provided with a layer of ductile metal 12, such as vapor deposited silver, in FIg. 1d. Onto this ductile metal layer is provided a layer of nickel 13, such as by electrolytic deposition, in FIG. 1e. FIG. 1f illustrates bonding of the silicone daughter mold to a support substrate 14 on the side adjacent the nickel layer 13. Note the volume under the pattern element is shown as a void, however this volume may be filed by a conformable support substrate, or may be filled with a bonding adhesive. In FIG. 1g the silicone 11 is removed from the nickel layer such that the ductile metal layer 12 remains attached to the deposited nickel 13, yielding a submaster have the positive pattern elements relative to the original master, and opposite those of the first generation daughter.

An alternate embodiment is shown in FIGS. 1h and 1i. Here, a relatively thick layer of nickel is provided, which may fill any voids in the back surface of the mold. This relatively thick layer of deposited nickel may be ground or machined to any desirable thickness, and provide a rigid, planar surface for subsequent replication.

FIG. 2 illustrates an alternate embodiment of the invention. A master mold 21 is contacted with a silicone resin and cured to provided a first generation daughter mold 22 having negative pattern elements relative to the master. In FIG. 2d, the first generation daughter mold 22 is used to produce a second generation daughter mold 23 having positive pattern elements, relative to the master 21. The second generation daughter mold is then provided with a ductile metal layer 24, then a deposited nickel layer 25, bonded to an optional substrate 26, and the nickel and second generation daughter mold separated, such that the ductile metal layer remains attached to the nickel layer.

### EXAMPLES

### Example 1

a) Process for Fabrication of the Master Mold

An anti-reflective coating (ARC UV-112, available from Brewer Science, Rolla, Mo.) was applied to the surface of a Si wafer (available from Montco Silicon Technologies, Inc., Spring City, Pa.) before applying a photoresist, in order to avoid degradation of the pattern due to reflected light. A 15 μm thick layer of SU-8 photoresist (available from MicroChem Corp., Newton, Mass.) was coated onto the ARC-coated Si wafer by spin coating, followed by baking at a temperature of 65° C. for 2 min and then 95° C. for 2 min.

The SU-8 photoresist (a negative photoresist commercially available from Micro-Chem Inc. of Santa Clara, Calif.) was exposed using a conventional photolithography system (obtained from Neutronix Quintal Corp., Morgan Hill, Calif.) in order to obtain post and hole structures. After the exposure, a post-exposure bake (PEB) at 65° C. for 2 min and then 95° C. for 2 min was performed to selectively cross-link the exposed portions of SU-8 photoresist. The SU-8 was then developed in propylene glycol methyl ether acetate (PGMEA, available from MicroChem Corp., Newton, Mass.) and treated with a fluorinated silane release agent before the next step of polydimethylsiloxane (PDMS) replication.

SEM images of SU-8 post and hole structures revealed the post diameter is about 7.2 μm, the post height is about 15 μm, and the pitch is 11 μm. The hole diameter is 7.5 μm, its depth is about 15 gm, and the pitch is 11 μm.

b) Silicone 1^{st} generation daughter mold made from the SU-8 photoresist master structure of step a:

Poly(dimethylsiloxane) (PDMS) and its curing agent (available as SYLGARD 184 Silicone Elastomer Kit, available from Dow Corning, Midland, MI) were thoroughly mixed in a 10:1 weight ratio. Air bubbles trapped in the mixture were removed by degassing for 30 min at low vacuum. The degassed mixture was poured onto the patterned SU-8 (from part a), further degassed for another 30 min, and then cured on a hot plate at 80° C. for 1 h. After the curing, the silicone negative mold was peeled off the SU-8 master, yielding the desired silicone 1^{st} generation daughter mold with negative pattern elements (relative to the master).

c) Ni mold made from silicone 1^{st} generation daughter mold

The patterned surface of the 1^{st} generation negative mold was provided with a 75 nm thick Ag layer (ductile metal layer) by e-beam evaporation (Mark 50, available from CHA Industries, 4201 Business Center Drive, Fremont, Calif. 94538). Then a stainless steel support disk was adhered to the non-patterned surface of the daughter mold with double-stick tape. A nickel layer was deposited on the silvered, patterned surface of the daughter mold by electrolytic deposition. A nickel sulfamate bath was used at a temperature of 130 F (54° C.) and a current density of 20 ampere per square foot (ASF). The thickness of the nickel deposit is about 20 mils. After the electrolytic deposition was completed, the nickel submaster, having the silver layer was separated from the silicone daughter mold.

### Comparative Examples 2a-f

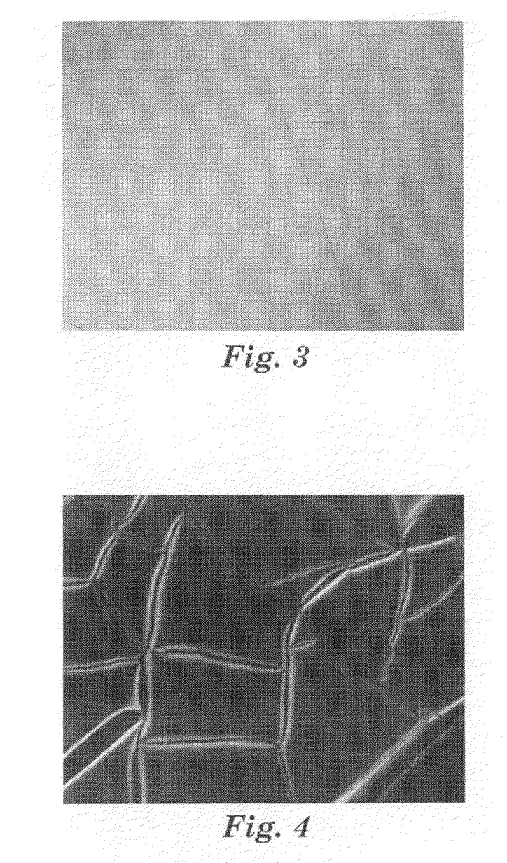

A 10 nanometer layer of nickel instead of silver was provided to a silicone daughter mold using essentially the procedure of Example 1. FIG. 3 shows extensive cracking of the vapor deposited nickel layer.

After deposition of the 10 nanometer nickel layer, the sample was adhered to a stainless steel disk with double-stick tape. A nickel layer was deposited on the nickeled, patterned surface of the daughter mold by electrolytic deposition. A nickel sulfamate bath was used at a temperature of 130 F (54° C.) and a current density of 20 ampere per square foot (ASF). The thickness of the nickel deposit is about 20 mils. After the electrolytic deposition was completed, the nickel submaster, having the silver layer was separated from the silicone daughter mold. Due to the extensive cracking of the vapor deposited nickel layer, the submaster was unsuitable for subsequent accurate replications.

In a separately prepared sample using a layer of 100 nanometer deposited nickel, more cracks were observed due to stress in the Ni film on the PDMS mold as seen in FIG. 4. Similarly, silicone daughter molds having 10 nanometers titanium, 75 nanometers palladium, 75 nanometers chromium, and 75 nanometers copper were prepared and showed significant cracking. A daughter mold prepared using 75 nanometers deposited aluminum showed very minor cracking. It is believed that thinner aluminum deposited layers would yield smoother crack-free coatings.

### Example 3

### Crack-Free Silver Layer on PDMS Mold

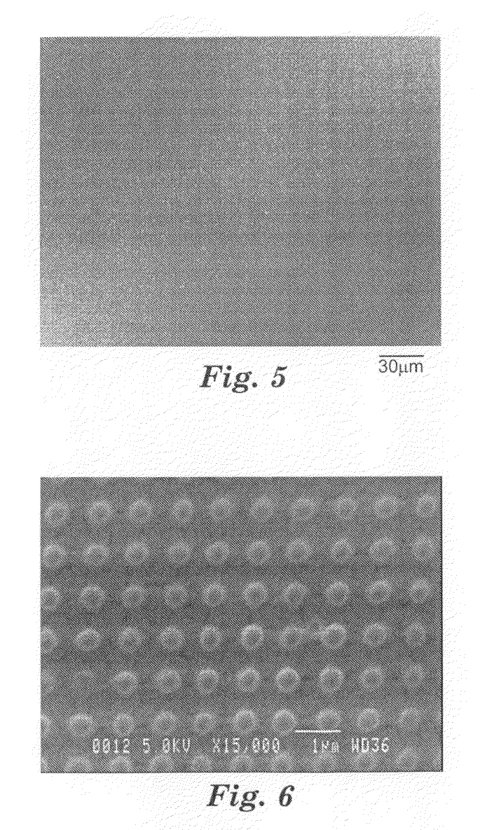

Using essentially the procedure of Example 1, a ductile silver layer of 100 nanometers was deposited on a silicone daughter mold by electron beam evaporation (Mark 50, available from CHA Industries, 4201 Business Center Drive, Fremont, Calif.), without any tie layer. In contrast to Ni films, no crack in the Ag films was observed. FIG. 5 shows the smooth, crack-free surface of the deposited silver layer.

A stainless steel support disk was adhered to the non-patterned surface of the daughter mold (with the 100 nanometer Ag layer) with double-stick tape. A nickel layer was deposited on the silvered, patterned surface of the daughter mold by electrolytic deposition. A nickel sulfamate bath was used at a temperature of 130 F (54° C.) and a current density of 20 ampere per square foot (ASF). The thickness of the nickel deposit is about 20 mils. After the electrolytic deposition was completed, the nickel submaster, having the silver layer, was separated from the silicone daughter mold as shown in FIG. 6.

In a separately prepared sample, a 150 nanometer layer of silver was deposited, using essentially the same procedure. The 150 nm thick Ag layer shows a rough surface in contrast to the 100 nanometer thick layer.

Table 1 summarizes the performance of different Ag film thicknesses on the PDMS daughter molds for subsequent Ni electroplating. Note that root-mean-square (RMS, Rq) roughness increases with the Ag thickness. It was found that the silver mirror reaction does not occur on the thinnest Ag layer (10 nm) probably because such a thin layer is not a continuous conducting film.

TABLE 1
Ag thicknesses, roughness (Rq) and performance of Ni electroplating

| Ag thickness | Roughness | Ni | |
|---|---|---|---|
| (nm) | (Rq, nm) | electroplating | Remarks |
| 10 | 0.5 | No | 10 nm Ag is too thin for Ni |
| | | | plating, discontinuous |
| 75 | 5 | Yes | Suitable for preparation of Ni |
| | | | submaster |
| 100 | 8 | Yes | Suitable for preparation of Ni |
| | | | submaster |
| 150 | 40 | Yes | 150 nm Ag is too rough for Ni |
| | | | electroplating |

1. A method of replicating a mold comprising the steps of :
a) providing a patterned silicone daughter mold;
b) depositing a layer of a ductile metal to a thickness of 10-100 nanometers on the patterned surface of said daughter mold;
c) depositing a layer of nickel metal to a thickness of 0.2 to 5 mm on the patterned surface of said daughter mold;
d) optionally securing the article of step c to a substrate;
e) separating the deposited nickel layer having a patterned surface to produce a submaster mold, said patterned surface having a layer of a ductile metal thereon.

2. The method of claim 1 wherein said ductile metal layer has a mean surface roughness of less than 10.

3. (canceled)

4. The method of claim 1 wherein the ductile metal has a % elongation at break of at least 50%.

5. The method of claim 4 3 wherein the ductile metal has Vickers hardness of 25 kilograms-force per square millimeter (kgf/mm²) or less.

6. The method of claim 1 wherein the ductile metal is selected from is gold, silver, tin or indium.

7. The method of claim 1 wherein the step of depositing a layer of a ductile metal is a vapor depositing step.

8. The method of claim 1 wherein said silicone is selected from addition curable silicones, condensation curable silicones, free-radical curable silicones, and cationic curable silicones.

9. The method of claim 1 wherein the pattern elements of said submaster mold surface are 100 nanometers to 15,000 micrometers in cross section and have a repeat distance of 10 nanometers to 15,000 micrometers.

10. The method of claim 1 wherein the patterned silicone daughter mold is a first generation daughter mold prepared from a master mold.

11. The method of claim 1 wherein said first generation daughter mold is prepared by the steps of:
i. providing a master mold have a positive pattern on the surface thereof;
ii. contacting the master mold with a curable silicone and curing,
iii. removing the cured silicone mold having a negative pattern on the surface thereof,
iv. first depositing a layer of a ductile metal on the negative patterned surface;
v. next electroplating a layer of nickel metal on the negative patterned surface having a ductile metal layer;
vi. optionally securing the article of step v to a substrate;
vii. separating the electroplated nickel layer having a positive patterned surface from said silicone to produce a first generation daughter mold, said patterned surface having a layer of a ductile metal thereon.

12. The method of claim 1 wherein patterned silicone daughter mold is a second generation daughter mold prepared from a first generation silicone daughter mold, wherein the first generation silicone daughter mold is prepared from master mold.

13. The method of claim 11 wherein said second generation daughter mold is prepared by the steps of:
a) providing a master mold have a positive pattern on the surface thereof;
b) contacting the master mold with a curable silicone and curing,
c) removing the cured silicone mold having a negative pattern on the surface thereof,
d) contacting the cured silicone mold having a negative pattern on the surface thereof with a curable silicone;
e) removing the cured silicone mold having a positive pattern on the surface thereof;
f) first depositing a layer of a ductile metal on the positive patterned surface;
g) next depositing a layer of nickel metal on the positive patterned surface;
h) optionally securing said article of step g to a support;
i) separating the electroplated nickel layer having a positive patterned surface to produce a second generation daughter mold, said patterned surface having a layer of a ductile metal thereon.

14. A method of replicating comprising the steps of
a) providing the submaster mold of claim 1;
b) contacting the submaster mold with a curable silicone and curing,
c) removing the cured silicone mold having a pattern on the surface thereof to produce a second generation daughter mold;
d) optionally repeating steps b to c.

15. The method of claim 13 wherein said curable silicone resin is selected from addition curable silicones, condensation curable silicones, free-radical curable silicones, and cationic curable silicones.

16. The method of claim 13, where said replication is repeated at least ten times.

17. A nickel submaster mold having a layer of ductile metal on the patterned surface thereof.

18. The nickel submaster of claim 16 wherein the thickness of the ductile metal layer is from greater than 10 to less than 100 nanometers.
